(19) United States
(12) Patent Application Publication
(10) Pub. No.: US 2011/0227259 A1
(43) Pub. Date: Sep. 22, 2011

(54) METHODS OF FORMING SINTERED BORON CARBIDE

(75) Inventors: Vimal K. Pujari, Northborough, MA (US); James T. Hennessey, Rutland, MA (US); Christopher J. Reilly, Whitlnsville, MA (US)

(73) Assignee: Saint-Gobain Ceramics & Plastics, Inc., Worcester, MA (US)

(21) Appl. No.: 12/841,474

(22) Filed: Jul. 22, 2010

Related U.S. Application Data
(60) Provisional application No. 61/271,694, filed on Jul. 24, 2009.

(51) Int. Cl. C04B 35/645; C04B 35/64

(52) U.S. Cl. 264/604; 264/603

(57) ABSTRACT

A method of forming a sintered boron carbide body includes washing boron carbide powder with essentially pure water at an elevated temperature to generate low oxygen boron carbide powder, mixing a sintering aid and a pressing aid with the low oxygen boron carbide powder to form a green mixture, and shaping the green mixture into a green boron carbide body. The method can include mixing titanium carbide powder having an average particle diameter in a range of between about 5 nm and about 100 nm with the low oxygen boron carbide powder. The method can further include sintering the green boron carbide body, and hot isostatic pressing the sintered body, to a density greater than about 98.5% of the theoretical density (TD) of boron carbide. Alternatively, the method can include sintering the shaped boron carbide green body at a temperature greater than about 2,200° C., to thereby form a eutectic liquid solid solution of B₄C/SiC, forming a sintered boron carbide body with a density greater than about 98% TD.

### RELATED APPLICATION

This application claims the benefit of U.S. Provisional Application No. 61/271,694, filed on Jul. 24, 2009.

The entire teachings of the above application are incorporated herein by reference.

### BACKGROUND OF THE INVENTION

Boron carbide (B₄C) materials are of great interest as engineering ceramics for armor, wear resistant structural components, and as abrasives. Most applications of boron carbide materials require a high density which is close to the theoretical density (TD). Boron carbide materials generally have been made using either hot pressing techniques (i.e., sintering under high pressure) or pressureless sintering (i.e., sintering without applying pressure).

Typically, hot pressing processes are limited to relatively small and geometrically simple articles, and are generally energy intensive and require additional molding materials. Attempts have been made to replace hot pressing by pressureless sintering in manufacturing articles from a composite material such as boron carbide. Pressureless sintering is advantageous compared to hot pressing with respect to process costs and ability to process in a continuous mode and/or a scale-up to commercial production. Generally, it has been a challenge for conventional pressureless-sintering processes to obtain sintering densities of more than about 95% TD. Thus, there is a need for developing an improved pressureless-sintering process to manufacture high density boron carbide materials or products.

### SUMMARY OF THE INVENTION

The present invention generally relates to methods of pressureless sintering of boron carbide to a density greater than about 97% of the theoretical density of boron carbide.

A method of forming a sintered boron carbide body can include washing boron carbide powder with essentially pure water at an elevated temperature to generate low oxygen boron carbide powder, and mixing a sintering aid and a pressing aid with the low oxygen boron carbide powder to form a green mixture. In some embodiments, the method further includes mixing titanium carbide powder having an average particle diameter in a range of between about 5 nm and about 100 nm with the low oxygen boron carbide powder to form the green mixture. In certain embodiments, the titanium carbide can be present in an amount in a range of between about 0.5 wt % and about 3 wt %. The method further includes shaping the green mixture into a green boron carbide body. In some embodiments, the method further includes sintering the green boron carbide body in an atmosphere in which it is substantially inert at a pressure of up to about one atmosphere, and hot isostatic pressing the sintered body, under pressure of a gas in which the sintered body is substantially inert, to thereby form a sintered boron carbide body having a density greater than about 98.5% of the theoretical density of boron carbide. The sintering aid can include an amount of silicon carbide powder in a range of between about 3 wt % and about 10 wt %, with an average particle diameter of less than or equal to about 1.3 μm. In some embodiments, the sintering aid can also include an amount of carbon in a range of between about 3 wt % and about 8 wt %. The pressing aid can include an amount of polyethylene glycol in a range of between about 2 wt % and about 8 wt %. The step of sintering the green body can be conducted at a temperature in a range of about 2100° C. to about 2300° C., for a time period in a range of about 1 hour to about 3 hours. The step of hot isostatic pressing the sintered body can be conducted at a temperature in a range of about 1900° C. to about 2150° C., for a time period in a range of about 1 hour to about 3 hours, under a gas pressure in a range of about 15,000 lb/in² to about 60,000 lb/in².

Alternatively, the method includes milling boron carbide using grit comprising silicon carbide, washing boron carbide powder with essentially pure water at an elevated temperature to generate low oxygen boron carbide powder, and mixing a boron carbide sintering aid with the low oxygen boron carbide powder to form a green mixture. The method further includes sintering the green boron carbide body in an atmosphere in which it is substantially inert, to thereby form a sintered boron carbide body with a density greater than about 97% of the theoretical density of boron carbide that includes β-SiC. The boron carbide powder can have a surface area in a range of about 15 m²/g to about 20 m²/g. The sintering aid can include an amount of carbon in a range of between about 2 wt % and about 12 wt %.

The methods of this invention produce sintered boron carbide bodies with improved strength, elastic modulus, and hardness for use as armor components for military and police protection, for example.

### BRIEF DESCRIPTION OF THE DRAWINGS

The foregoing will be apparent from the following more particular description of example embodiments of the invention, as illustrated in the accompanying drawings. The drawings are not necessarily to scale, emphasis instead being placed upon illustrating embodiments of the present invention.

FIG. 1 is a photograph of a sintered boron carbide body made by sintering over a 50/50 bed of SiC/B₄C at about 2250° C. for about 3 hours in an Argon atmosphere, thereby achieving a sintered density of 2.47 g/cc (98% TD).

FIG. 2 is a graph of an EDS spectrum of a eutectic liquid phase at a grain boundary (Region B) of the sintered boron carbide body of FIG. 1.

FIG. 3 is a photograph of a sintered boron carbide body made by sintering over a carbon bed at about 2210° C. for about 3 hours in an Argon atmosphere, thereby achieving a sintered density of 2.462 g/cc (97.7% TD).

FIG. 4 is a photograph of a boron carbide body made by pressureless sintering followed by hot isostatic pressing under gas pressure showing a eutectic liquid phase (white regions) at the grain boundaries.

FIG. 5 is a photograph of a sintered boron carbide body including 1 wt % titanium carbide having an average particle diameter in a range of between about 17 nm and about 35 nm. The sintered boron carbide body was made by sintering over a carbon bed at about 2180° C. for about 3 hours in an Argon atmosphere, thereby achieving a sintered density of 2.44-2.45 g/cc (97.3% TD).

FIG. 6 is a photograph of a close-up of the sintered boron carbide body shown in FIG. 5, including the A, B, and C regions having TiB₂, SiC (with B₄C as solid solution), and B₄C (with SiC as solid solution), respectively.

### DETAILED DESCRIPTION OF THE INVENTION

The method of preparing a sintered boron carbide material of the invention employs washing boron carbide powder with essentially pure water at an elevated temperature to generate low oxygen (less than about 3 wt % O₂) boron carbide powder. The boron carbide powder suitable for use in the invention can be amorphous or crystalline. See application Ser. No. 12/221,916 filed on Aug. 7, 2008.

As used herein, “essentially pure water” means a liquid having at least 90 wt % of pure water (H₂O). Preferably, boron carbide powder is washed with at least 93 wt % pure water, more preferably with at least 95 wt % pure water. Optionally, the water for the washing process is degassed. As used herein, “elevated temperature” means a temperature greater than about 20° C. Preferably, the elevated temperature for washing of the boron carbide powder is in a range of between about 70° C. and about 90° C. More preferably, the elevated temperature for washing of the boron carbide powder is about 80° C., Preferably, the boron carbide powder is washed for between about 1 hour and about 3 hours. More preferably, the boron carbide powder is washed for about 2 hours.

Prior to the washing step, the boron carbide powder optionally is milled with essentially pure water. Preferably, the boron carbide powder is milled to have an average particle size less than about 2 microns, more preferably between about 0.1 microns and 1 micron, more preferably between about 0.3 microns and about 0.8 microns, even more preferably between about 0.5 microns and about 0.8 microns, such as about 0.6 microns. The average surface area of the milled boron carbide powder is preferably at least about 13 m²/g, more preferably between about 10 m²/g and about 20 m²/g, such as about 15 m²/g.

The milling can be done with any suitable grinding means. Preferably, the milling is done with a silicon carbide (SiC) grit. In one specific embodiment, the silicon carbide grit has a grit size of 500 to 2000 microns. In another specific embodiment, the milling process of boron carbide powder with a silicon carbide grit generates silicon carbide powder worn down from the grit along with milled boron carbide powder. The mixture is optionally screened with a filter to remove any remaining grit bigger than the threshold of the filter, for example, about 325 microns. The amount of silicon carbide powder can be controlled by adjusting parameters of the milling process, for example, milling time. Preferably, the amount of the silicon carbide powder is in a range of between about 5 wt % and about 28 wt %, more preferably between about 5 wt % and about 20 wt %, even more preferably between about 5 w % and about 15 wt % (e.g., about 10 wt %), of the total weight of the final boron carbide material.

Any suitable milling medium known in the art can be employed for the milling process. Preferably, the milling medium is an aqueous medium. In one specific embodiment, the aqueous medium includes about 80 wt % water on the basis of the total weight of the milling medium. In another specific embodiment, the aqueous medium includes water and an alcohol component, such as isopropyl alcohol. Preferably, a weight ratio of water to alcohol, such as methanol, ethanol, or isopropyl alcohol, is in a range of between about 3:1 and about 5:1, more preferably about 4:1. In a more specific embodiment, the milling medium includes about 80 wt % of water, about 20 wt % of alcohol, such as isopropyl alcohol, and about 1 wt % silane. In some other embodiments, a dry milling method is employed.

The washed boron carbide powder is combined with a sintering aid. Any suitable sintering aid known in the art can be employed. Examples include silicon carbide powder, preferably with an average particle diameter of less than or equal to about 1.3 μm, and any suitable carbon precursors, such as carbon-containing organic compounds (e.g., phenolic resins), and elemental carbon (carbon black or graphite), or combinations thereof. The sintering aid can be employed in any form that ensures a uniform distribution in the highly disperse mixture, for example as a particulate or colloid. The carbon precursor, such as a carbon-containing organic compound, can be coked to form carbon at temperatures of, for example, up to about 1,000° C. More preferably, the carbon precursor decomposes at a temperature in a range of between about 100° C. and about 900° C. Examples of such carbon precursors include phenolic resins, phenoplasts, coal-tar pitch and phenolformaldehyde condensation products of phenolic resins.

The silicon carbide sintering aid is in an amount corresponding to between about 3 wt % and about 28 wt % on the basis of the weight of the boron carbide powder, preferably about 4.5 wt %, with an average particle diameter of less than or equal to about 1.3 μm. Preferably, the silicon carbide is mixed with an amount of carbon in a range of between about 3 wt % and about 8 wt % carbon on the basis of the weight of the boron carbide powder. In one embodiment, the carbon is a phenolic resin. In a specific embodiment, an aqueous solution of the phenolic resin is combined with the washed boron carbide powder.

The washed boron carbide powder is combined with a pressing aid. Any suitable pressing aid known in the art can be employed, such as, for example, polyethylene glycol. The pressing aid is in an amount corresponding to between about 2 wt % and about 8 wt % on the basis of the weight of the boron carbide powder.

The mixture of the washed boron carbide powder, sintering aid, and pressing aid is dried employing any suitable method known in the art. Examples of suitable drying methods include freeze dry and spray dry. Preferably, the mixture is freeze dried.

A desired shape, such as a desired three-dimensional shape, of boron carbide can be formed by pressing the dried mixture of boron carbide powder, sintering aid, and pressing aid into a green body. The shaping can be carried out according to any suitable known method, for example, by die-pressing, cold isostatic pressing, injection molding, extruding or slip casting. In the case of die-pressing in molds or isostatic pressing, a pressure of from 30 to 600 MPa, preferably from 100 to 500 MPa, is generally used. Any desired three-dimensional shape can be formed, such as, for example, disks.

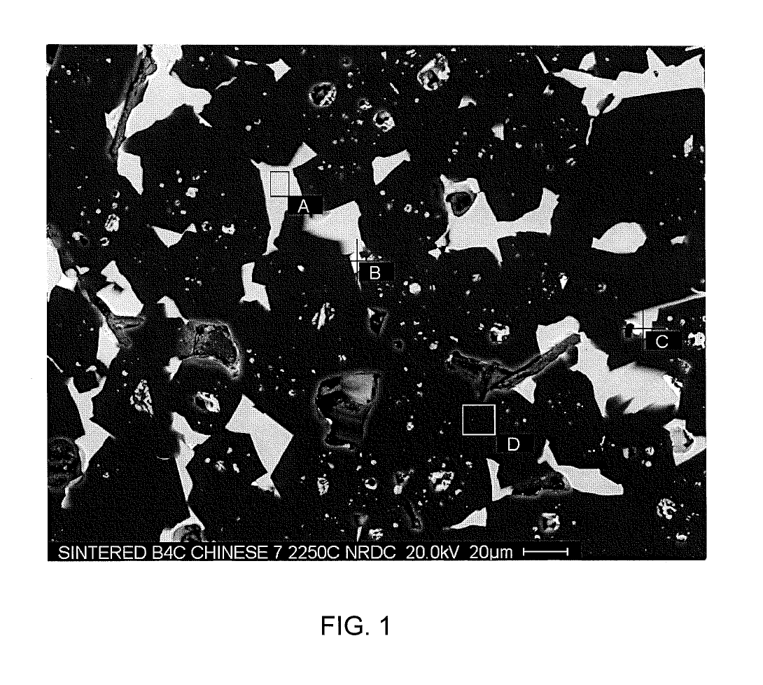

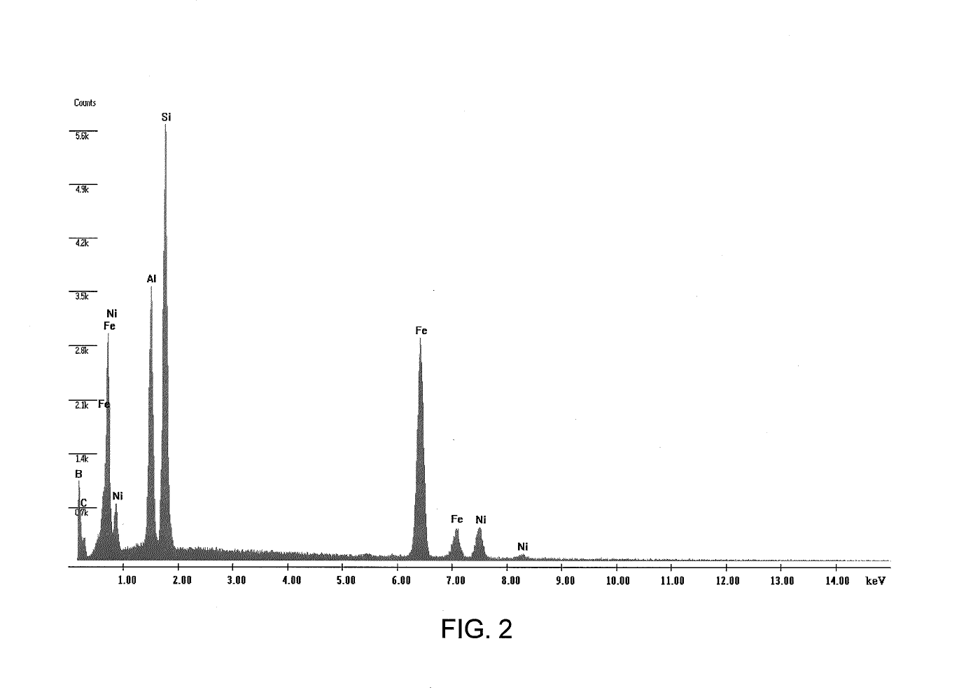

In certain embodiments, the shaped green body of boron carbide is sintered to thereby form a corresponding sintered boron carbide body. Preferably, the sintering of the shaped boron carbide green body is conducted in the absence of external pressure. The pressureless-sintering process can be carried out in any desired high-temperature furnace, such as a graphite-tube resistance furnace (Tammann furnace) or an induction-heating furnace having a graphite susceptor. For continuous operation, a horizontal pusher or band-type furnace can be employed, in which the preshaped boron carbide body is transported through the heating zone and, in such a manner, that each article is maintained at the desired end-temperature for a given period of time. The period of time for heating, the dwell time at the final temperature and the cooling are, in that operation, dependent on the size of the shaped material to be sintered. In a specific embodiment, the shaped boron carbide green body is sintered at a temperature in a range of between about 2,100° C. and about 2,300° C., preferably greater than about 2,200° C. In one preferred embodiment, a shaped boron carbide green body including about 7 wt % SiC is sintered at about 2210° C. Typically, the sintering process extends for about 1-3 hours, preferably for about 3 hours. In another preferred embodiment, the shaped boron carbide body is pre-heated at a temperature in a range of between about 550° C. and about 650° C. prior to the sintering of the shaped boron carbide material. Preferably, the sintering and/or optional pre-heating processes are conducted under an inert atmosphere, such as under an Argon or a nitrogen atmosphere. The presence of a eutectic liquid solid solution of B₄C/SiC in an embodiment shown in FIG. 1, is confirmed by the electron diffraction spectroscopy (EDS) spectrum shown in FIG. 2, by the presence of Al, Fe, and Ni impurities in the liquid phase, which is identified as Region B in FIG. 1.

In a specific embodiment, the sintered boron carbide body is then hot isostatically pressed (HIP), under an inert atmosphere, such as an argon or a nitrogen atmosphere, to thereby form a sintered boron carbide body having a density greater than about 98.5% of the theoretical density of boron carbide. Preferably, the sintered boron carbide body is hot isostatically pressed at a temperature in a range of about 1900° C. to about 2150° C., for a time period in a range of about 1 hour to about 3 hours, under a gas pressure in a range of about 15,000 lb/in² (15 KSI) to about 60 KSI, more preferably at a temperature of about 2000° C., for a time period of about 2 hours, under an Argon gas pressure in a range of about 15 KSI to about 30 KSI, preferably about 30 KSI.

In another embodiment, a boron carbide powder with a starting surface area of about 4 m²/g is milled in an aqueous suspension using silicon carbide grit as grinding medium. The aqueous suspension consists of 80% water and 20% isopropyl alcohol (IPA). A starting suspension with 50% solids of boron carbide powder and a pH of about 9 is prepared. In order to further minimize the oxidation of boron carbide powder, a silane in the amount of 1% of the solids in the suspension is used. The silane can be obtained commercially such as, for example, product number Z-6040 from Dow Corning (Midland, Mich.). This slurry is then milled in an attrition mill until a surface area and D50 of greater than 15 m²/g and 0.55 μm, respectively, are achieved. This slurry is then washed in warm water at about 80° C. to remove the surface oxygen (in the form of B₂0₃). The process is repeated several times until the total oxygen content is below about 3 wt %. Subsequently, to this washed powder, 12 wt % phenolic resin and 3 wt % PEG400 were added by making an aqueous solution (about 80% water and about 20% IPA). Polyethylene Glycol 400 (PEG400) is a low molecular weight grade of polyethylene glycol that can be obtained commercially from, for example, Sigma-Aldrich (St. Louis Mo.).

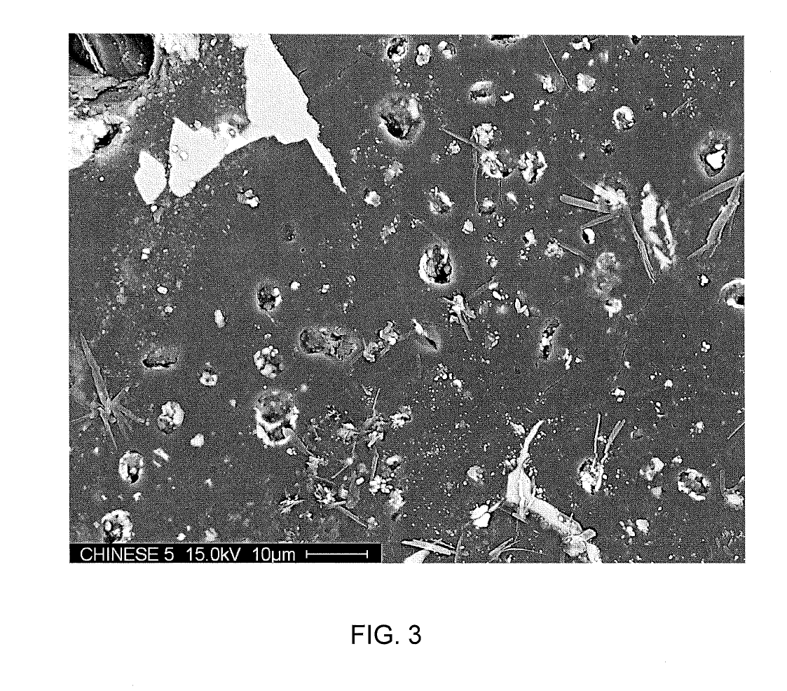

The well mixed slurry is then sprayed dried into free-flowing granules. The granules are pressed into test tiles at 18 KSI. The pressed samples are then sintered at about 2210° C. for three hours in Argon in a graphite crucible. Typical sintered density in the range of 97.5 to 98.5% theoretical density (TD) is achieved. An example is shown in FIG. 3. At this temperature, a eutectic liquid is formed by reaction between silicon carbide (added through the attrition of silicon carbide grinding media) and boron carbide. The formation of eutectic liquid helps to improve the densification during sintering. The eutectic liquid transforms into beta silicon carbide during cool down from the sintering temperature, which is confirmed by post quantitative XRD.

In yet another specific embodiment, a boron carbide body is made by mixing a low oxygen content boron carbide powder (<3 wt % oxygen) with about 15 m²/g surface area, with 4 wt % carbon (as phenolic resin), and finely powdered (approximately 1 μm particle size) 6.8 wt % silicon carbide. The mixture is shaped into a green body by pressing the mixture of boron carbide powder and sintering aid as described above. The green boron carbide body is placed in contact with a green silicon carbide body in a sintering container, such as, for example, a graphite crucible, preferably over a powder bed of 50/50 SiC/B₄C or carbon powder. The green silicon carbide body preferably includes a sintering aid as described above, more preferably about 5 wt % carbon and about 0.5 wt % boron carbide, based on the weight of silicon carbide. The two bodies are then sintered using the time and temperature conditions described above, to thereby form a sintered boron carbide body with a density greater than about 99% of the theoretical density of boron carbide and a sintered silicon carbide body that includes β-SiC. In an example embodiment, it was observed that a eutectic type liquid phase was formed after sintering near the SiC/B₄C contact region, and that the liquid had also diffused throughout the sintered boron carbide body. Analysis of the sintered boron carbide body showed a density of 2.498 g/cm³ (˜99% TD) with a liquid phase at the grain boundaries. Hardness, as measured with a 1 Kg load, and fracture toughness, measured with a 2 Kg load, were measured to be 26.8 GPa and 3.56 MPam^{1/2}, respectively. These results are believed to be at least 20% and 78% higher, respectively, than values reported in the literature. The eutectic liquid was also analyzed by electron diffraction spectroscopy (EDS) and X-ray diffraction (XRD), which revealed only β-silicon carbide.

In still another specific embodiment, a boron carbide body is made by mixing a low oxygen content boron carbide powder (<3 wt % oxygen, preferably 2 wt % oxygen) with a surface area in a range of between about 12 m²/g and about 20 m²/g, preferably about 15 m²/g, with carbon (as phenolic resin) in a range of between about 3 wt % and about 5 wt % carbon, preferably about 4 wt % carbon, finely powdered (approximately 1 μm particle size) in a range of between about 1 wt % and about 10 wt % silicon carbide, preferably about 4.5 wt % silicon carbide, and titanium carbide powder having an average particle diameter in a range of between about 5 nm and about 100 nm, preferably in a range of between about 17 nm and about 35 nm. Suitable titanium carbide powder (nano-TiC) can be obtained, for example, from SDC Materials, Inc. (Tempe, Ariz.). See application Ser. No. 12/152,096 of Biberger et al., published as U.S. 2008/0277270 on Nov. 13, 2008. A well mixed aqueous suspension of 0.5-3 wt % nano-TiC, preferably about 1 wt %, at pH 7.4 is added to a well dispersed aqueous suspension of B₄C, containing about 50 wt % solids, at pH 9.5. The boron carbide powder typically has the same specifications as described above. After addition, the composite slurry is sonicated for about 30 minutes. Next, about 2-8 wt % carbon sintering aid, preferably about 4 wt %, is added in the form of phenolic resin or carbon black, preferably phenolic resin, and the mixture is well mixed using a high shear mixer. The mixture is then either spray dried or freeze dried as described above to form a green mixture.

In this specific embodiment, the green mixture is shaped into a green boron carbide body by pressing the mixture of boron carbide powder and sintering aid as described above to about 62% TD. The green boron carbide body is then sintered in a graphite crucible over a powder bed of carbon powder, in an atmosphere in which it is substantially inert, preferably an Argon atmosphere, at a temperature in a range of between about 2100° C. and about 2300° C., preferably in a range of between about 2180° C. and about 2200° C., for a time period in a range of between about one hour and about 4 hours, preferably about 3 hours. During sintering, a partial vacuum is maintained, at an absolute pressure in a range of between about 10 mTorr and about 200 mTorr, preferably about 50 mTorr, while the sintering temperature rises from about 1350° C. to about 2050° C. An inert atmosphere, preferably Argon, is present inside the furnace at ambient pressure during the rest of the heating cycle of the sintering step. A sintered boron carbide body having a density of at least about 97% of the theoretical density of boron carbide is formed thereby.

Sintered boron carbide bodies made according to the methods described above are useful for light weight armor, neutron absorbers for nuclear reactors, wear parts, dressing sticks (e.g., for grinding wheels), etc.

### EXEMPLIFICATION

A high surface area (about 15 m²/g), low oxygen content (about 2.8 wt %) low cost boron carbide powder containing 6.8 wt % silicon carbide particles below about 1.3 μm, about 5 wt % carbon and about 3 wt % pressing aid (PEG 400) was die pressed (about 4 KSI) and cold isostatically pressed (CIP) to a green density of about 57% TD. The carbon and pressing aid were added to the B₄C powder in an aqueous suspension by dissolving phenolic resin and PEG 400, respectively.

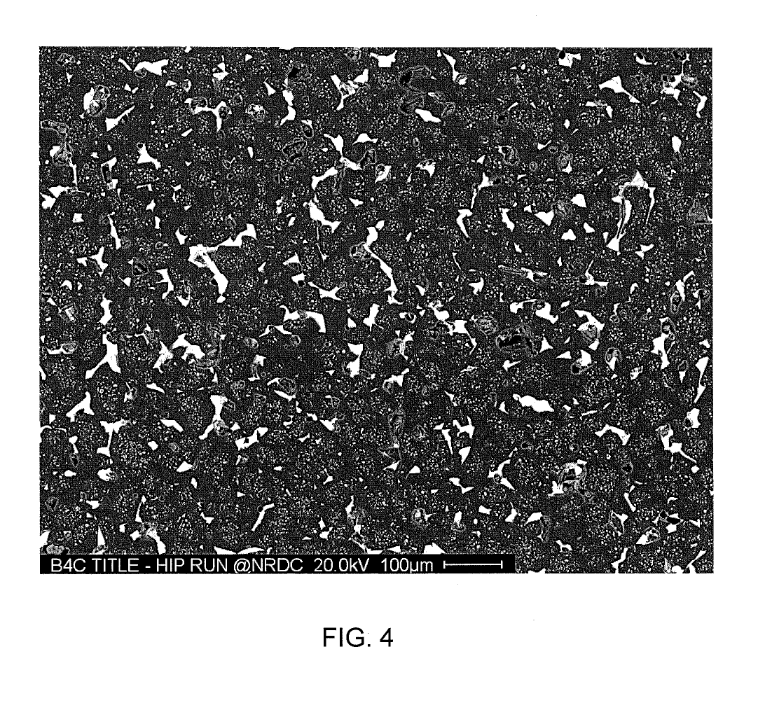

The shaped green body was sintered in an Argon gas environment at about 2230° C. for about a 3 hour hold time to a closed porosity density of 94% TD (2.4 g/cc). This pressureless sintered B₄C body was further densified to near theoretical density using post sintering gas pressure hot isostatic press (HIP) treatment. The HIP parameters used were 2000° C./30 KSI/2 Hr/Argon. A photomicrograph of the sintered boron carbide body is shown in FIG. 4.

A summary of results for sintered boron carbide bodies produced using the methods described above is shown in Table 1, where the numbers in brackets are standard deviations, and typical hot pressed results are also shown for comparison.

TABLE 1
Measured properties of sintered boron carbide bodies

| | | | | Fracture | Fracture |
|---|---|---|---|---|---|
| | | Hardness | Hardness | Toughness- | Toughness- |
| | | (GPa) | (GPa) | KIC | KIC |
| Sintering | Density | 1 Kg | 1 Kg | (MPa-m^{1/2}) | (MPa-m^{1/2}) |
| Location | (g/cc) | Vickers | Knoop | 1 Kg | 2 Kg. |
| NRDC | 2.43-2.46 | 27-31.43 | 22.58 | 3.15 | 3.25 |
| 2210C/3 Hr/Ar | | (5.37) | (1.6) | (0.3) | |
| C/SiC Bed or | | | | | |
| B4C/SiC Bed | | | | | |
| Niagara Falls | 2.42 | 30.4 | 22.4 | | 3.10 |
| (Sinter + HIP) | | (4.8) | (1.4) | | (0.59) |
| Sinter-2230C/3 Hr/Ar | | | | | |
| HIP-2000C/2 Hr/A | | | | | |
| Hot Pressed | 2.49 | 31.15 | | | 2.68 |
| 2150C/3 Hr/Ar | | (1.18) | | | (0.25) |

Boron Carbide Bodies with Nano-Titanium Carbide

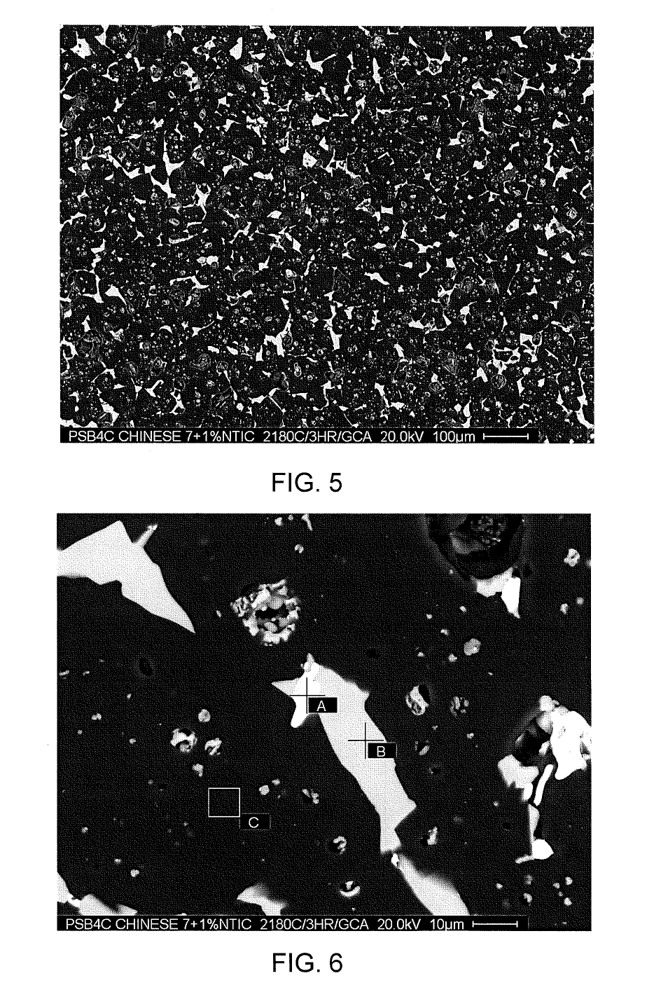

Two boron carbide compacts (pressed to about 62% TD) were made from a low oxygen content (less than 3 wt % oxygen) B₄C powder with a surface area of about 15 m²/g. The boron carbide compacts contained 4 wt % carbon (as phenolic resin), fine (about 1 micron) 4.5 wt % silicon carbide and 1 wt % titanium carbide (17-35 nm average particle size). The compacts were placed on a carbon black bed inside a graphite crucible and sintered in a partial vacuum Argon gas environment for about 3 hours, one at 2180° C. and the other at 2200° C. A partial vacuum was maintained during sintering between 1350° C. and 2050° C. Argon gas at ambient pressure was present inside the furnace during the rest of the sintering heating cycle. A photograph of the resulting microstructure of the boron carbide body sintered at 2180° C. is shown in FIG. 5. The sintered boron carbide bodies had a density of 2.44-2.45 g/cc (about 97.3% TD). The boron carbide body sintered at 2180° C. had a hardness of 26.65 GPa, and a fracture toughness (KIC) of 2.68 MPa-m^{1/2}. The boron carbide body sintered at 2200° C. had a hardness of 27.18 GPa and a fracture toughness (KIC) of 2.84 MPa-m^{1/4}. The areas indicated as A, B, and C in FIG. 6 are TiB₂, SiC (with B₄C as solid solution), and B₄C (with SiC as solid solution), respectively.

The teachings of all patents, published applications and references cited herein are incorporated by reference in their entirety.

### EQUIVALENTS

While this invention has been particularly shown and described with references to example embodiments thereof, it will be understood by those skilled in the art that various changes in form and details may be made therein without departing from the scope of the invention encompassed by the appended claims.

What is claimed is:

1. A method of forming a sintered boron carbide body comprising:
a) washing boron carbide powder with essentially pure water at an elevated temperature to generate low oxygen boron carbide powder;
b) mixing a sintering aid and a pressing aid with the low oxygen boron carbide powder to form a green mixture;
c) shaping the green mixture into a green body;
d) sintering the green body in an atmosphere in which it is substantially inert at a pressure of up to about one atmosphere; and
e) hot isostatic pressing the sintered body, under pressure of a gas in which the sintered body is substantially inert, to thereby form a sintered boron carbide body having a density greater than about 98.5% of the theoretical density of boron carbide.

2. The method of claim 1, wherein the boron carbide powder has a surface area in a range of about 10 m²/g to about 20 m²/g.

3. The method of claim 1, wherein the sintering aid includes an amount of silicon carbide powder in a range of between about 3 wt % and about 10 wt %, with an average particle diameter of less than or equal to about 1.3 μm, and also includes an amount of carbon in a range of between about 3 wt % and about 8 wt %.

4. The method of claim 1, wherein the sintering aid includes an amount of silicon carbide powder in a range of between about 3 wt % and about 10 wt %, with an average particle diameter of less than or equal to about 1.3 μm.

5. The method of claim 1, wherein the pressing aid includes an amount of polyethylene glycol in a range of between about 2 wt % and about 8 wt %.

6. The method of claim 5, wherein the step of sintering the green body is conducted at a temperature in a range of about 2100° C. to about 2300° C., for a time period in a range of about 1 hour to about 3 hours.

7. The method of claim 1, wherein the step of hot isostatic pressing the sintered body is conducted at a temperature in a range of about 1900° C. to about 2150° C., for a time period in a range of about 1 hour to about 3 hours, under a gas pressure in a range of about 15,000 lb/in² to about 60,000 lb/in².

8. A method of forming a sintered boron carbide body comprising:
a) milling boron carbide using grit comprising silicon carbide;
b) washing boron carbide powder with essentially pure water at an elevated temperature to generate low oxygen boron carbide powder;
c) mixing a boron carbide sintering aid with the low oxygen boron carbide powder to form a green mixture;
d) shaping the green mixture into a green boron carbide body;
e) sintering the green boron carbide body in an atmosphere in which it is substantially inert, to thereby form a sintered boron carbide body with a density greater than about 97% of the theoretical density of boron carbide that includes β-SiC.

9. The method of claim 8, wherein the boron carbide powder has a surface area after milling in a range of about 15 m²/g to about 20 m²/g.

10. The method of claim 8, wherein the sintering aid includes an amount of carbon in a range of between about 2 wt % and about 12 wt %.

11. The method of claim 8, wherein the step of sintering the green bodies is performed at a temperature in a range of about 2100° C. to about 2300° C., for a time period in a range of about 1 hour to about 3 hours.

12. A method of forming a sintered boron carbide body comprising:
a) washing boron carbide powder with essentially pure water at an elevated temperature to generate low oxygen boron carbide powder;
b) mixing titanium carbide powder having an average particle diameter in a range of between about 5 nm and about 100 nm, a sintering aid, and a pressing aid with the low oxygen boron carbide powder to form a green mixture;
c) shaping the green mixture into a green body;
d) sintering the green body in an atmosphere in which it is substantially inert at a pressure of up to about one atmosphere; and
e) hot isostatic pressing the sintered body, under pressure of a gas in which the sintered body is substantially inert, to thereby form a sintered boron carbide body having a density greater than about 97% of the theoretical density of boron carbide.

13. The method of claim 12, wherein the boron carbide powder has a surface area in a range of about 10 m²/g to about 20 m²/g.

14. The method of claim 12, wherein titanium carbide is present in an amount in a range of between about 0.5 wt % and about 3 wt %.

15. The method of claim 12, wherein the sintering aid includes an amount of silicon carbide powder in a range of between about 3 wt % and about 10 wt %, with an average particle diameter of less than or equal to about 1.3 μm, and also includes an amount of carbon in a range of between about 3 wt % and about 8 wt %.

16. The method of claim 12, wherein the sintering aid includes an amount of silicon carbide powder in a range of between about 3 wt % and about 10 wt %, with an average particle diameter of less than or equal to about 1.3 μm.

17. The method of claim 12, wherein the pressing aid includes an amount of polyethylene glycol in a range of between about 2 wt % and about 8 wt %.

18. The method of claim 12, wherein the step of sintering the green body is conducted at a temperature in a range of about 2100° C. to about 2300° C., for a time period in a range of about 1 hour to about 3 hours.

19. The method of claim 12, wherein the step of hot isostatic pressing the sintered body is conducted at a temperature in a range of about 1900° C. to about 2150° C., for a time period in a range of about 1 hour to about 3 hours, under a gas pressure in a range of about 15,000 lb/in² to about 60,000 lb/in².
